(19) United States
(12) Patent Application Publication
(10) Pub. No.: US 2006/0242329 A1
(43) Pub. Date: Oct. 26, 2006

(54) Power-efficient encoder architecture for data stream on bus and encoding method thereof

(76) Inventors: Tien-Fu Chen, Chia-Yi (TW); Tsung-Min Hsieh, Chia-Yi (TW); Chun-Li Wei, Chia-Yi (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/108,792

(22) Filed: Apr. 19, 2005

(51) Int. Cl. G06F 3/00

(52) U.S. Cl. 710/3

(57) ABSTRACT

The present invention discloses a power-efficient encoder architecture for address stream on bus and a power-efficient encoding method for address stream on bus. In the design of the encoder architecture, a encoder is installed on the path along which the address stream flows from the central processing unit to a bus, and another encoder is installed on the path along which the address stream flows from the bus to a memory, and the aforementioned encoders all have the encode/decode function. In the design of the encoding method, each address stream is equipped with a corresponding stride, wherein the strides of different address streams are not necessarily the same; the related stride can be used to predict hit stride and help calculating the address where the next data stream will appear; the stride of each address stream can be dynamically modified, and the transferred contents for the address stream corresponds to the portion that enables the bus capacitors to switch less times; the maximum switching number of the bus capacitors is reduced to two to the K-th power. Via the encoding of the present invention, the switching number of the bus capacitors can be reduced to the least with the same transmission frequency, and thus the objective of reducing the power consumption of the bus is achieved.

### BACKGROUND OF THE INVENTION

1. Field of the Invention

The present invention relates to a power-efficient encoding architecture for address stream on bus and a encoding method thereof, particularly to a encoding architecture and a encoding method wherein via integrating an improved encoding architecture and a flexible encoding method, the effective encode/decode can reduce the switching number of the bus capacitor in address stream transmission without sacrificing the working frequency to achieve the objective of reducing power consumption.

2. Description of Related Art

When designing the product of 3C application, power dissipation, particularly that of a system chip, is as important as space exploitation and operation rate. How to solve the above-mentioned problems and achieve higher operation efficiency is always a subject that the electronic industry endeavors to study and desires to overcome.

In the general operation and transmission process of a computer, data and operation results, after processed by central processing unit (CPU) 2, is transferred from the CPU 2 to a memory 3 by means of an original address stream 11 with a bus 4 as the transmission medium, as shown in FIG. 1A, and then, according to the address indicated by the original address stream 11, the contents of the data stream stored temporarily in the memory 3 is accessed. The charge/discharge of the capacitors is utilized to record the signal change, and the high-speed switching capacitor is usually adopted in the bus 4 to meet the demand of high-speed transmission. The more complex the data word of the original address stream 11, the more the switching number (times of charge/discharge) of the capacitors, and the higher the working frequency of the system, the higher the switching frequency of the capacitor. Thus, high-speed access activity induces high power consumption in I/O process, which, however, is that the designer expects not to see, and with the high temperature working environment, low working efficiency of the electronic device is not beyond anticipation. Accordingly, a lot of researches, which shows reducing the power consumption of the bus via decreasing the switching number of the capacitors, have been undertaken in recent years in order to achieve the objective of reducing power consumption.

### SUMMARY OF THE PRESENT INVENTION

The primary objective of the present invention is to provide a power-efficient encoding architecture for address stream on bus, wherein an address stream is previously encoded into a format needing less switching activities when the address stream is stored into a memory in order to reduce the power consumption.

Another objective of the present invention is to provide a power-efficient encoding method for address stream on bus, which modifies an address stream into a format needing the least number of net transmissions so that the power consumption can be reduced via the least switching number of the bus capacitors during access.

To achieve the aforementioned objectives, in the power-efficient encoding architecture for address stream on bus of the present invention, an encoder is installed in front of the bus on the transmission path of an address stream, and a decoder is installed in front of a memory on the transmission path of the address stream; thus, even the address stream is encoded/decoded, however, the content of the address stream is unchanged, and thereby, the workload of the bus capacitors can be shared by the aforementioned encoder/decoder, so that the switching frequency of the address stream transmission on so-called off-chip bus is decreased and the power consumption is reduced.

The present invention also provides a power-efficient encoding method for address stream on bus, which adopts a K-hot means wherein the binary code word of an encoded address stream will not exceed K bits of ‘1’s and the other bits are to be ‘1’s so that the address stream will become simpler and the switching number of the capacitors will be reduced. Via the reconstruction of the address stream, the next address stream (i.e. the address of the upcoming data stream) can also be predicted; thereby, the next address stream can be predicted directly in the decoder side, and the transmission contents can previously correlates to the portion with less change; thus, the switching number of the bus capacitors can be accompanied further reduced, i.e. its working load is decreased; therefore, the better power efficiency can be achieved.

Via the detailed description of the preferred embodiments in cooperation with the attached drawings, the objectives, technical contents, characteristics and accomplishments of the present invention is to be more easily understood.

### BRIEF DESCRIPTION OF THE DRAWINGS

FIG. 1A is schematic block diagram of a general address stream transmission.

FIG. 1B is schematic block diagram according to an embodiment of the encoder architecture of the present invention.

FIG. 2 is schematic block diagram of the constituent elements of the encoder according to an embodiment of the present invention.

FIG. 3 is schematic block diagram according to an embodiment of the encoding method of the present invention.

FIG. 4A is schematic diagram according to an embodiment of the modification mechanism of the present invention.

FIG. 4B is schematic diagram according to an embodiment of the prediction mechanism of the present invention.

### PREFERRED EMBODIMENTS OF THE INVENTION

The present invention is a power-efficient encoder architecture for address stream on bus and power-efficient encoding method for address stream on bus, wherein its design for lower power consumption is based on the principle “Reducing content changes of address streams to reduce switching number of bus capacitors”. The preferred embodiments of the invention are described below.

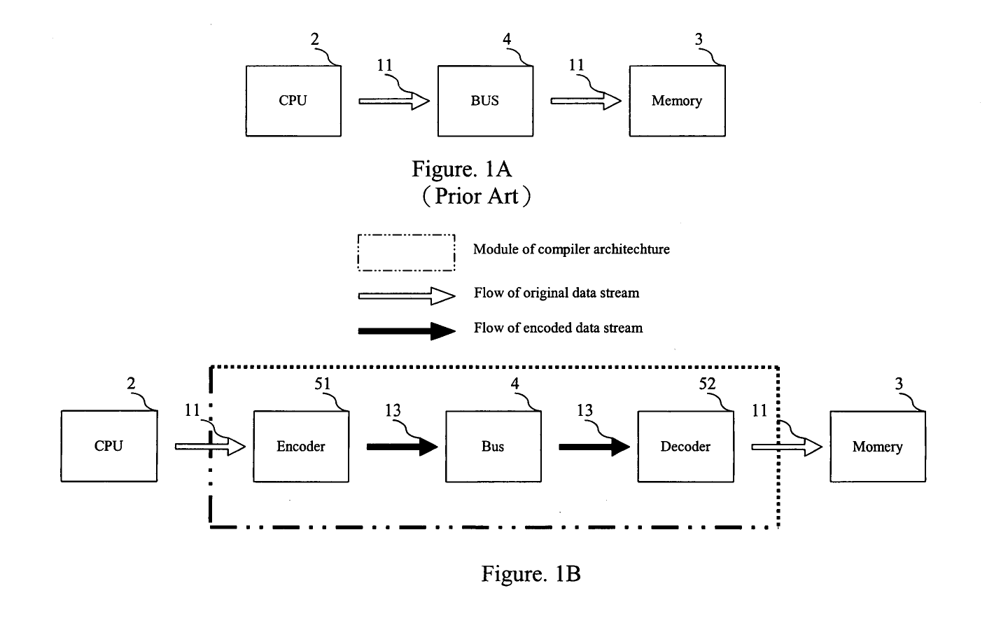

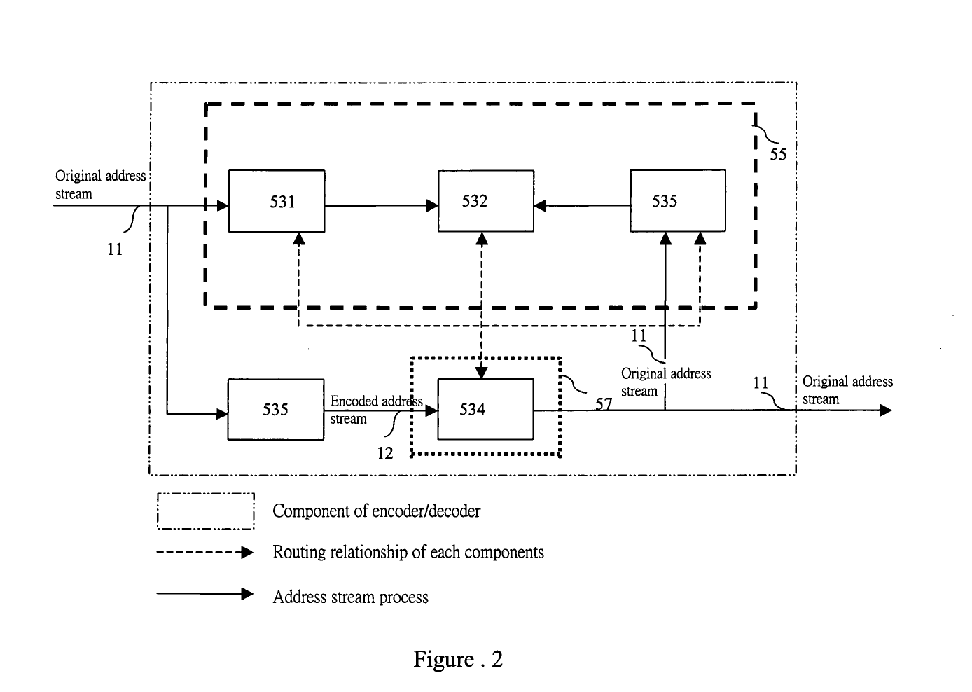

As shown in FIG. 1B, a general original address stream 11 means “the address of the data stream in a memory, which heads for a target with the transmission path from a central processing unit (CPU) 2 through a bus 4 to a memory 3”. The aforementioned CPU 2 can arrange and output the address stream 11, and the bus 4 is a transmission medium of original address stream, and the memory 3 is a device where data temporarily stored. The present invention improves the aforementioned transmission way and can apply to the embodiment with the transmission on off-chip bus. The embodiment is that on the transmission path of the original address stream 11, an encoder 51 is installed between the CPU 2 and the bus 4, and a decoder 52 is installed between the bus 4 and the memory 3. Via the aid of the encoder 51/decoder 52 separately disposed at each end of the bus 4, the original address 11 with a complex format is pre-encoded into a simpler one, i.e. the format of the encoded address stream 12, in order to reduce the switching (charge/discharge) number of the capacitors of the bus 4; thus, the electricity consumed can be lowered, and therefore, the power consumption is also reduced. Each of the encoder 51/decoder 52 mentioned above is an encoder. In fact, the internal hardware structures of both are the same in the present invention; however, as the installing locations and the tasks or usages assigned are different, different element names are given to each for identifying each other and distinguishing one from the other in function. For the convenience of refit and use, the aforementioned encoder 51, bus 4 and decoder 52 can be arranged in sequence to form a wrapper of module and the wrapper of module provided by the present invention can be completed just by replacing the original bus directly with the module mentioned above. As shown in FIG. 2, the aforementioned encoder 51(same as decoder 52) comprises: an address stream storage device 531, an address stream-related stride storage device 532, a multiplexer 533, a finite state machine 534 and a previous address stream storage device 535, wherein the address stream storage device 531 can be replaced by a content addressable memory (CAM) 536.

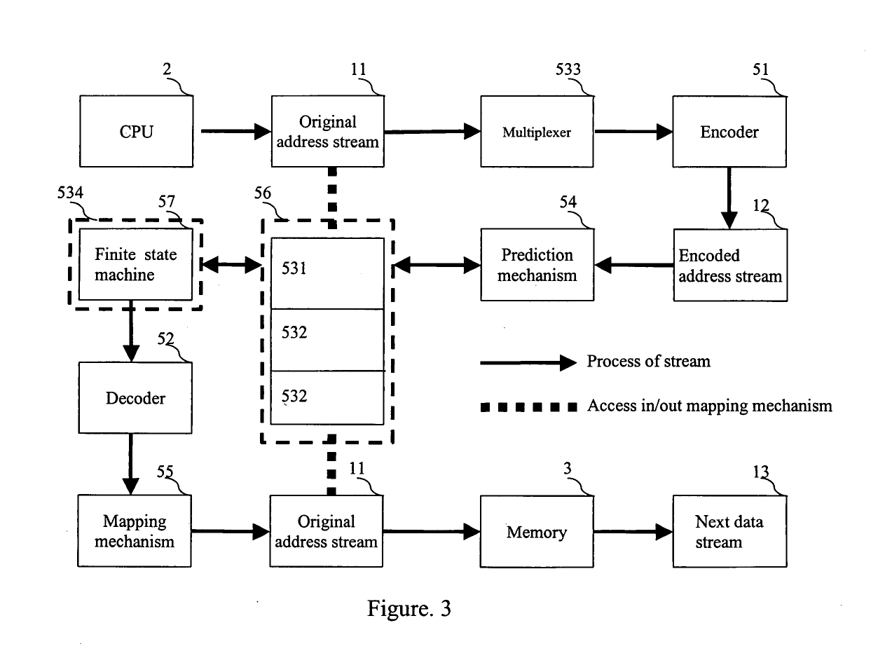

As shown in FIG. 2 and FIG. 3, firstly the original address stream 11 and its stride sent out by the CPU 2 are separately stored in the address stream storage device 531 and the address stream-related stride storage device 532 mentioned above, and the original address stream 11 is encoded. The present embodiment adopts a flexible K-hot encoding wherein the binary code word of the encoded address stream possesses the format with K bits of ‘1’s and the other bits are of ‘0’ value. The so-called 1-hot means that the binary code word of the encoded data stream possesses 1 bit of ‘1’ and the other bits are of ‘0’ value; it is apparent that when the data stream transferred on the bus, the less the K value used by the encoding, the less the number of switching activities between 0 and 1 or between 1 and 0; for example, when K=1 and the anterior and the posterior data are different, as the code word of each has only one bit of ‘1’, only two switching activities of the capacitors is needed during the transmission process of the data stream 1. Similarly, when K=2, two to the second power of switching activities are needed, i.e. four switching activities at most are needed, and with the other value of M, wherein M≦=K, is respectively to 2^{M}, its results can be inferred from those mentioned above similarly.

Then, the present invention provides a multiplexer 533, which selects the output value of the encoder 51, i.e. the aforementioned value of K. Owing to the influence of the value of K described above, the output value will influence the code word pattern of the encoded address stream 12. From the view of machine, the less the switching number, the more power is saved; however, more time is expended on the encode/decode process. Conversely, when the switching number is higher, more power is consumed on the transmission of the bus 4, but the encode/decode process needs less time, which is adaptable to a high-speed operation. Therefore, how to balance or compromise between the encode/decode speed and the power consumption is a key factor in the product design.

And, according to the contents of the original address stream 11, the multiplexer 533 determines an appropriate output value to achieve an optimal balance or compromise between the operation speed and the power consumption. When the original data stream 11 is transferred from the CPU 2 to the bus 4, based on the experience of the conventional technology that reducing the switching number of the bus 4 capacitors can reduce the power consumption, the present invention adopts the flexible K-hot encoding to encode the original address stream 11 into the encoded address stream 12 with a simpler format, which enables the bus's 4 capacitors to need only the least times of switching activities under the same transmission speed when the encoded address stream 12 flows through the bus 4, so that in the present invention, the objective of obviously reducing the power consumption can be achieved with the same operation frequency.

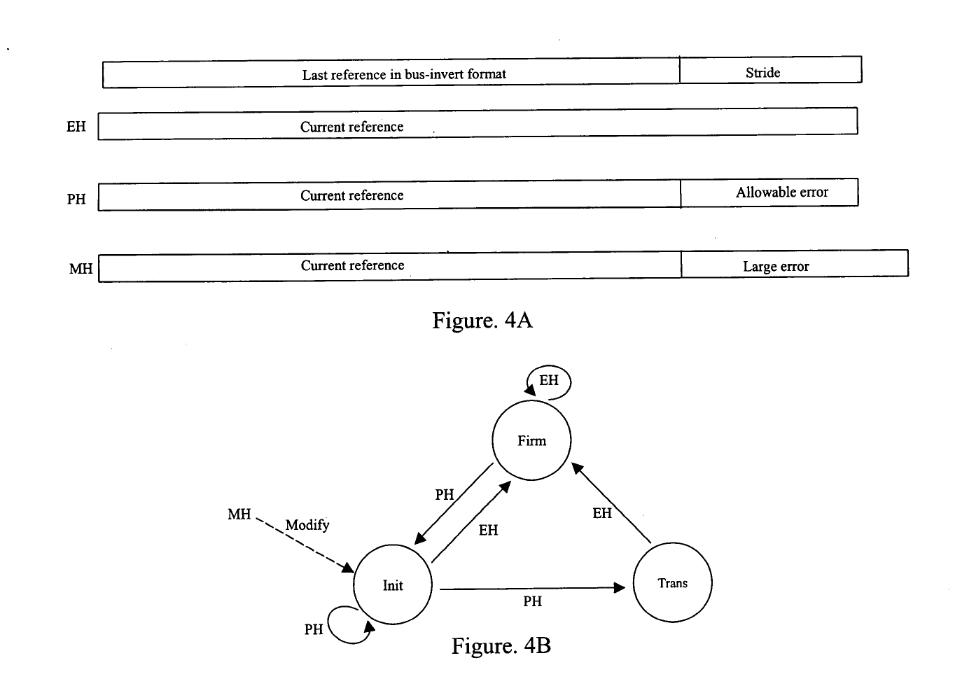

Then, the encoded address stream 12 is processed by a prediction mechanism 54. It is to be noted that each of the address streams does not necessarily have the same value of the stride (in fact, it usually has different value of stride). The stride represents the distance between the address of the current data stream and the address where the next data stream appears. The present invention utilizes the characteristics that each stride is not necessarily the same to reconstruct and record each encoded address stream 12 in order to predict the address where the next data stream 13 appears; thus, the unnecessary access activity can be avoided, and the access activity of the bus 4 and the encoder 51/decoder 52 can be saved as much as possible so that the objective of reducing power consumption can be achieved. The practice thereof needs a mapping mechanism 55, which is formed of a memory address stream lookup table 56 that comprises: the aforementioned address stream storage device 531, an address stream-related stride storage device 532, and the previous address stream storage device 535. The present invention utilizes a finite state machine 534 to determine a stride firstly, and then the selected stride is stored in the address stream-related stride storage device 532; then, a Last Reference of active data stream and a Current Reference of active data stream are selected from the address stream storage device 531 and the previous address stream storage device 535 in the memory address stream lookup table 56, wherein the Reference values are transferred via the bus 4 in the form of address stream. As shown in FIG. 4A, the prediction conditions can be categorized into the following three ones:
(1) Exact Hit (EH), indicating that Last Reference+stride=Current Reference;
(2) Partial Hit (PH), indicating that Last Reference+stride=Current Reference±allowable error;
(3) Missed Hit (MH), indicating that Last Reference+stride≠Current Reference±allowable error.

As shown in FIG. 4B, for the finite state machine 534, the prediction states are divided into three kinds of states:
(1) Initial State, indicating Standard State that the prediction has not started yet;
(2) Transient State, indicating that the prediction is being undertaken and hasn't been completed yet
(3) Firm State, indicating that the prediction has been completed.

When the prediction condition is of Exact Hit (EH), i.e. Current Reference=Last Reference+predicted stride, the machine will directly adopt the Current Reference and then stays in Firm State, and thus the update of the stride is completed.

When Partial Hit (PH) appears repeatedly, the machine will jump from Firm State to Initial State and then to Transient State; while in Transient State, the difference between Current Reference and Last Reference is worked out; the difference is to be a modified stride, and as shown in FIG. 4, it is worked out by:
modified stride=Current Reference−Last Reference.

At this moment, the Last Reference will jump across the distance of the modified stride to reach the Current Reference, which enables the prediction condition to jump to Firm State to complete the update activity.

When the prediction condition is of Missed Hit (MH), a difference can also be worked out to represent the distance between the Current Reference and the Last Reference; however, as the difference between these two Reference values is too large, the present invention demands that the Current Reference is transferred directly lest too much time be spent on too many operations.

The aforementioned modification process is performed by a modification mechanism 57 provided by the finite state machine 534. Via the working rules of those three prediction conditions and three prediction states, the present invention dynamically tracks the encoded address stream 12 and its stride, and then provides an appropriate stride needed by the dynamic modification, and then predicts the next address stream 13 during the process of the dynamic modification, i.e. the address of the next data stream 13.

And, as shown in FIG. 3, in the stage near outputting, the present embodiment decodes the encoded address stream 12 via the decoder 52. The aforementioned stride prediction and dynamic stride modification is to enable the bus 4 to be able to work least, and the modification activities corresponding to three prediction conditions EH, PH and MH mentioned above are described below separately:
(1) When Exact Hit (EH), i.e. Current Reference=Last Reference+stride, as the present invention has built the aforementioned mapping mechanism 55, several Reference values (last one and several ones before last) of active address stream are stored therein to enable the system to be able to work in a simpler way such that the bus 4 only needs to transfer the aforementioned Last Reference and once the decoder 52 receives the Last Reference, the current reference will be got by adding the exactly hit stride to the Last Reference and then the data stream corresponding to the address in the memory 3 is directly accessed.
(2) When Partial Hit (PH), the operation is similar to that in EH; however, the stride originally predicted is with an allowable error, and if transferring the Last Reference as in EH, the decoder 52 side will not be able to guess the correct stride, which only induces vain guessing back and forth between the encoder 51 side and the decoder 52 side, and such departs from the present invention's objectives of reducing power consumption. The present invention alternatively adopts the aforementioned modified stride, and as the value of the modified stride is unique, the hit accuracy is pretty high. When the decoder 52 side receives the modified stride, with reference to the memory address stream lookup table 56, the modified stride is added to the Last Reference to get Current Reference. Then, the data stream corresponding to the address in the memory 3 is accessed.
(3) When Missed Hit (MH), the Current Reference is directly transferred to the decoder 52 side; as what is transferred is the Current Reference, it can be directly used to access the data stream indicated by the address without additional processing. In another embodiment, as the address stream transferred on the bus 4 in MH condition is Reference value plus stride value, which is apparently larger than the stride that is the only message needing transmission in EH or PH, an additional encoding technology of bus-invert format can be adopted to enable the encoded address stream 12 to be simpler in order to lower the workload of the bus. In fact, just the K-hot encoding processing of the present invention can make it simple enough, and whether to add the complementary bus-invert process is also a problem of balance and compromise between the operation rate and the power consumption, which is to be considered by the product designer.

After the decoder 52 completes the decoding step from any one of the aforementioned prediction conditions, the original address stream 11 got from the decoding step will be transferred to the memory 3, and via the Reference value implicated in the address stream, the data stream stored in the memory 3 can be accessed. Then, the system checks whether there is another address stream appearing in order to determine whether to encode the next address stream 13 or to come into an ending state. In fact, as the access activity is always being undertaken, the chance that CPU stops operating is rare. Furthermore, the decoded original address stream 11 can be stored into the aforementioned address stream-related stride storage device 532 and the previous address stream storage device 535, and after the repeated encode/decode processes, a great amount of address stream-related information is collected. The encoder/decoder and the related mechanisms of the present invention can refer to the address stream information anterior to encoding or posterior to decoding, and the more the address streams that have been encoded, the more efficient the utilization of the memory address stream lookup table 56 provided by the mapping mechanism 55; thus, the number of the prediction mechanism 54 that repeated searching or modifying the stride can be decreased, and the correct stride can be got further more rapidly, which can further reduce the power consumption and can also enhance the operation rate.

In definition, a bus is a medium for transferring the data stream, and according to the contents of the data stream or the elements coupled to both sides of the bus, the bus may be designated with various names, for example, the bus transferring the data stream between I/O devices is named I/O bus, and the bus transferring the data stream of address format is named address bus, and the bus transferring the data stream of pure data format is named data bus, and so on. Therefore, although the bus 4 takes charge of transferring the address stream flowing from the CPU 2 to the memory 3 in the present embodiment, the scope of the present invention is not limited to that. It is to be emphasized that those described above are only the preferred embodiments of the present invention and not intended to limit the scope of the present invention, and any equivalent modification or variation according to the spirit of the present invention is to be included within the scope of the present invention.

What is claimed is:

1. A power-efficient encoder architecture for address stream on bus, installed on the path along which the address stream of a data stream flows from the central processing unit to a memory, and comprising:
an encoder, positioned on said path of said address stream and coupled to said central processing unit to encode said address stream flowing to said bus;
a bus, positioned on said path of said address stream and in the rear side of said encoder to transfer said encoded address stream; and
a decoder, positioned on said path of said address stream and in the rear side of said bus to decode said encoded address stream transferred from said bus.

2. The power-efficient encoder architecture for address stream on bus according to claim 1, wherein said address stream, also named as data stream number, refers to a reference corresponding to said data stream's address and via said the reference address, the data stream stored in the corresponding memory address can be accessed.

3. The power-efficient encoder architecture for address stream on bus according to claim 1, wherein said encoder, said bus and said decoder can be arranged in sequence to form a module, which applies to embodiments with the off-chip bus.

4. The power-efficient encoder architecture for address stream on bus according to claim 1, wherein said encoder comprises:
an address stream storage device;
an address stream-related stride storage device;
a multiplexer, determining an appropriate output value;
a finite state machine, dynamically updating said stride; and
a previous address stream storage device.

5. The power-efficient encoder architecture for address stream on bus according to claim 4, wherein said address stream storage device can be replaced by a content addressable memory, CAM.

6. The power-efficient encoder architecture for address stream on bus according to claim 4, wherein said address stream storage device, said address stream-related stride storage device, and said previous address stream storage device can further apply to a memory address stream lookup table, which collates and records the difference between said address stream anterior to encoding and said address stream posterior to decoding.

7. The power-efficient encoder architecture for address stream on bus according to claim 4, wherein said finite state machine can further apply to a modification mechanism, which dynamically tracks the variation of said address stream and modifies said stride dynamically.

8. The power-efficient encoder architecture for address stream on bus according to claim 7, wherein said modification mechanism can further apply to a prediction mechanism, which predicts the address where the next address stream will appear via reconstructing said stride of said address stream.

9. A power-efficient compiling method for address stream on bus, which provides a flexible encoding process for the data stream flowing from the central processing unit to a memory, comprising the following steps:
determining an appropriate output value;
encoding said address stream flowing from said central processing unit;
predicting the next address stream, i.e. the address of the next data stream, via modifying the stride of said address stream;
determining an appropriate stride;
decoding said encoded address stream;
mapping said address stream anterior to encoding and posterior to decoding and its stride;
transferring said decoded address stream to said memory;
accessing the contents of the data stream corresponding to said address; and
repeating said steps until there is no new address stream appearing.

10. The power-efficient compiling method for address stream on bus according to claim 9, wherein each of said address streams has its corresponding stride and said stride of different address stream can have different values.

11. The power-efficient compiling method for address stream on bus according to claim 9, wherein said encoding is a flexible K-hot transformation step, and wherein after a binary encoding, the code word of said encoded address stream has K bits of ‘1’ at most and the other bits are ‘0’ value.

12. The power-efficient compiling method for address stream on bus according to claim 9, wherein the prediction conditions of said predicting step can be divided into exact hit, partial hit, and missed hit.

13. The power-efficient compiling method for address stream on bus according to claim 9, wherein said step of determining an appropriate stride can be divided into initial state, transient state, and firm state.

14. The power-efficient compiling method for address stream on bus according to claim 9, wherein said mapping step is to store the stride that is the most frequently used and point to the code word that has the least number of bits of ‘1’ into a memory address stream lookup table.
